(19) United States
(12) Patent Application Publication
(10) Pub. No.: US 2006/0148559 A1
(43) Pub. Date: Jul. 6, 2006

(54) Electronic gaming account service center

(76) Inventors: R. Jeffrey Jordan, Las Vegas, NV (US); Rena M. Schoonmaker, Las Vegas, NV (US)

Correspondence Address: BEYER WEAVER & THOMAS LLP, P.O. BOX 70250, OAKLAND, CA, 94612-0250, US

(21) Appl. No.: 10/820,431

(22) Filed: Apr. 7, 2004

(51) Int. Cl. A63F 13/00

(52) U.S. Cl. 463/29; 463/42; 463/25; 463/20

(57) ABSTRACT

Embodiments of the invention are directed to a self-service center upon which patrons and casino personnel can perform many casino related functions. For instance, after identifying themselves, a patron could access their player account to determine an account balance, or redeem some or all of their accumulated points for benefits, such as “comps”, promotions, coupons, cash, etc. Additionally the patron could “buy” additional bonus points, thereby increasing the number of accumulated bonus points in their account. The service center could also be connected to an ATM for dispersing funds or transferring funds to a player account.

### TECHNICAL FIELD

This disclosure relates to managing accounts, and, more specifically, to a system for managing player loyalty accounts in a networked gaming system.

### BACKGROUND

Gaming machines are popular entertainment devices. Present gaming machines provide an opportunity for a user to play a variety of popular games on the machines, such as fruit machines or slot-type games, video adaptations of standard card games like poker and blackjack, and many other types of games.

Modem gaming machines are coupled to a gaming network that performs many management type functions, such as accounting, game tracking, player tracking, bonusing and promotions. Players who identify themselves to the gaming network can accumulate bonus points by playing the games. The number of bonus points earned by the player may be based on their coin-in, outcomes of particular games, bonuses, specific promotions, etc.

These bonus points operate similarly to frequent flyer miles in that they accumulate in an account until they are used (or “spent”) by the player. Accumulated bonus points can be converted into machine credits, cash, or redeemed for awards, tickets to events, or other benefits.

Typically, the number of bonus points accumulated by a player is communicated to a player by showing the accumulated number on a player tracking system that is attached to a gaming device. Also, the particular casino or resort group that “owns” the player accounts may provide reports to players by mailing the reports. Additionally, a player may speak to a casino customer support representative who can access the report and give a report verbally. Generally, the customer support representative can access the account records quickly by using a computer terminal that has a secure login. For security, players cannot access the gaming network directly, other than at the game itself.

Although casinos try to staff customer service booths with enough employees to attend to all players' needs, it is difficult to accurately project how many employees will be needed at any given time. Having too many employees causes a casino to incur high labor costs, and reduces casino profits. Having too few employees can lead to customer frustration by having to wait for available employees to help the player. This can lead to the player not returning to the casino, also reducing casino profits.

Embodiments of the invention address these and other deficiencies in casino gaming systems.

### BRIEF DESCRIPTION OF THE DRAWINGS

The description may be best understood by reading the disclosure with reference to the accompanying drawings.

FIGS. 1A and 1B together form a block diagram of a gaming network according to embodiments of the invention.

FIG. 2 is a functional block diagram of a stand alone service center according to an embodiment of the invention.

FIG. 3 is an example flow diagram illustrating processes that can be performed by the service center of FIG. 2.

### DETAILED DESCRIPTION

Embodiments of the invention are directed to a self-service center upon which patrons can perform many casino related functions. For instance, after identifying themselves, a patron could access their player account. The patron could determine their account balance, and redeem some or all of their accumulated points for benefits, such as “comps”, promotions, coupons, cash, etc. Additionally the patron could “buy” additional bonus points, thereby increasing the number of accumulated bonus points in their account. A bill validator can be included that accepts bills. Similarly, a coin and token acceptor and hopper can accept and distribute coins and tokens. A bill dispenser can distribute currency. If the service center is connected to an ATM (Automated Teller Machine) network, the patron could withdraw money from an account, such as a bank account. Additionally, the player could transfer money from the bank account to their player account.

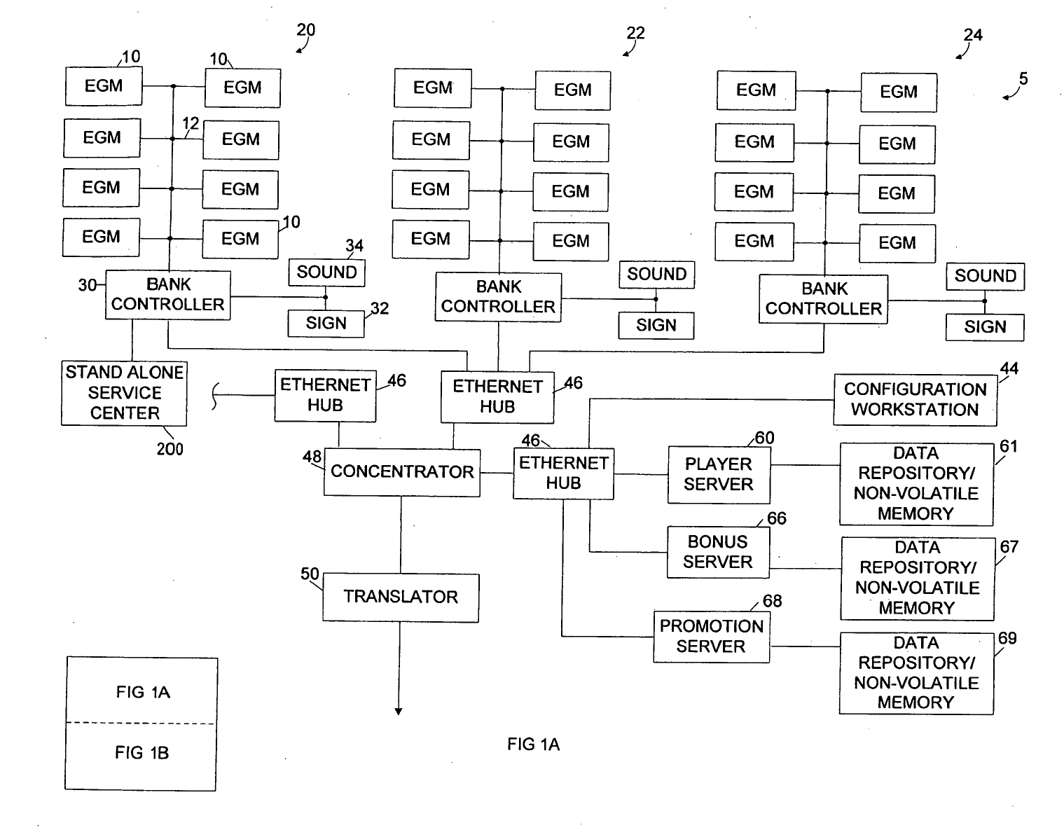

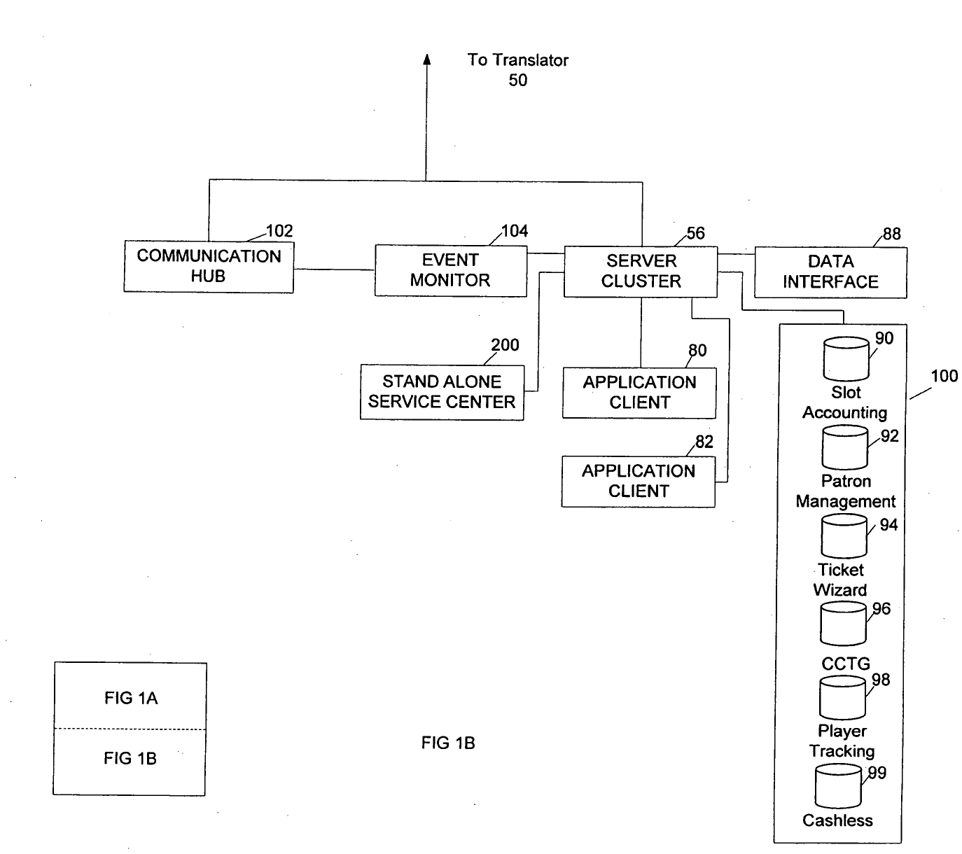

Embodiments of the invention operate on a gaming network, such as the networkillustrated in FIGS. 1A and 1B. Other gaming networks are described in U.S. Pat. No. 6,245,483B1, and U.S. patent application Ser. No. 10/308,768, both of which are assigned to the assignee of the present invention, and the teachings of both of which are incorporated herein in their entirety for all purposes.

In the gaming network 5 of FIGS. 1A and 1B, a number of EGMs 10 are organized in groups called banks. Individual banks 20, 22, and 24, can contain almost any number of gaming devices 10. Additionally, any number of banks is possible in a gaming network 5.

Each bank is controlled by a bank controller 30, which is coupled to each EGM 10 by a communication cable 12. The bank controller 30 facilitates data communication between the gaming devices 10 in its associated bank and the other components on the gaming network 5. In some embodiments, the bank controller 30 need not be present, and the EGMs 10 communicate directly with the other portions of the gaming network 5.

Configuration data for the gaming network 5 is stored in one or more network data repositories 61, 67, 69. In some embodiments, the data repositories 61, 67, 69 are made of battery backed-up non-volatile SRAM (Static Random Access Memory), which provides dual advantages of having extremely fast data input and output, and having a power source that is independent from the network 5 or the gaming devices 10. The data repositories 61, 67, 69 may also be mirrored, i.e., duplicate copies are made in real-time. This prevents data from being lost if one of the battery sources should fail or other catastrophic event. Data may be stored in the data repositories 61, 67, 69 using CRCs (Cyclic Redundancy Checks) and timestamps to ensure the data is valid and non-corrupt.

Configuration data is created at a configuration workstation 44 and stored in one or more of the data repositories 61, 67, 69. Configuration data may include message data for players as well as for promotions such as bonuses. Player message data is stored in the data repository 61, where it can be accessed by a player server 60. Player message data can include welcoming messages, card-in/card-out messages, and special messages about current promotions, for instance. The player server 60 reads the message data from the data repository 61 and sends a properly formatted message back to the bank controllers 30 and EGMs 10. These player messages may be displayed on a screen 32 for an entire bank, or may be shown on a screen directly mounted to the EGM 10 (not shown).

Other configuration data created at the configuration workstation 44 and stored in the data repositories 61, 67, 69 may include casino configuration data, such as identification of each EGM 10 on a casino floor. Additional parameters stored in the data repository 67, 69 are parameters used in promotions, such as bonus and other promotions. These parameters include such items as what EGMs 10 are included in the promotion, how to fund a bonus, i.e., if a bonus is funded by a portion of the coin-in amount of the EGMs 10, whether a paid bonus is to be taxed or un-taxed, and other parameters.

As players play the EGMs 10 in the gaming network 5, the EGMs send data from their coin meters, or meter values. One or more bonus server 66 and/or promotion server 68 stores these meter values, or summaries of the meter values, in its associated data repository 67, 69. The servers 66, 68 can also operate based on the present and stored meter values to determine an amount of money being wagered on the EGMs in near real-time. The servers 66, 68 can use the amount of money being wagered to calculate bonus pools that are funded as a percentage of the coin-in of participating EGMs 10. For instance, they can calculate a present amount of a bonus pool that is funded at one-half of one percent of the coin-in for the participating EGMs 10. An example of bonus promotions that can be operated from the bonus servers 66 includes LUCKY COIN and progressive bonuses, for example. Promotion servers 68 can implement bonuses or other promotions based on events that occur in any part of the gaming network. For example, triggering events may be satisfied by events based solely or partially on data stored in databases 100 (FIG. 1B). When a triggering event is satisfied, the promotion server 68 is notified over the computer network 5 and the promotion server 68 can institute the award for the player.

Of course, the servers 60, 66, 68 could be embodied in a single device, or in other configurations, and do not have to appear in FIG. 1A, which is only a functional representation. Likewise, the data repositories 61, 67, 69 could be embodied in a single device.

As data is generated by the EGMs 10, data is passed through communication hardware, such as Ethernet hubs 46, and a concentrator 48. Of course, switches or bridges could also be used. The concentrator 48 is also coupled to a translator 50, which includes a compatibility buffer so that the data from the EGMs 10 can be used by a server cluster 56 (FIG. 1B), and other parts of the gaming network 5.

The server cluster 56 (FIG. 1B) may, of course, be embodied by more than one physical server box. In practice, including multiple server boxes with dynamic load sharing and backup capabilities of one another ensures the gaming network 5 is nearly always operational.

The server cluster 56 is attached to and manages several databases, such as a slot accounting database 90, a patron management database 92, a ticket wizard database 94, a “Cage Credit and Table Games” (CCTG) database 96, a player tracking database 98, and a cashless database 99. These databases are collectively referred to as the databases 100. Of course these databases 100 are only exemplary, and more or fewer databases can be part of the gaming network 5. In some embodiments, particular servers in the server cluster 56 manage a single database. For example, a single server in the server cluster 56 may manage the slot accounting database 90, while another server manages the patron management database 92. Such implementation details are well within the expertise of one skilled in the art. However, for ease of illustration, FIG. 1 shows a single server cluster 56 that is coupled to all of the databases 100.

In operation, the slot accounting database 90 receives and stores statistical and financial information about the EGMs, such as dates, times, totals, game outcomes, etc. The patron management database 92 stores information regarding identified players, such as how often and which games they play, how often they stay in the casino, their total loyalty points, past awards, preferences, etc. The ticket wizard database 94 stores data about tickets that are issued by the EGMs, such as payouts and cashout tickets, as well as promotional tickets.

The CCTG database 96 stores information about non-EGM 10 data in a casino. That data is typically generated by a client station (not shown) coupled to one of the bank controllers 30. The client station can be located in a casino cage or at a table game, for instance, and data generated by the client station is forwarded to the CCTG database 96 where it is stored. For example, data such as when and how many chips a customer buys, when a customer creates or pays off markers, when a customer cashes checks, etc. is stored in the CCTG database 96.

The player tracking database 98 is a subset database of the patron management database 92, and is used when data retrieval speed is important, such as for real time promotions and bonusing. The cashless database 99 stores information about payment options other than bills, coins, and tokens.

Application clients 80 and 82 couple to the server cluster 56, and can retrieve data from any or all of the databases 100. Application programs run on an application client 80, 82 to provide users information about the gaming network 5 and the casino in which the network is established and to cause functions to operate on the gaming network 5. An example application client 80 could include, for instance, an accounting server that allows queries and provides reports on financial and statistical information on single or groups of EGMs 10.

A data interface 88 presents a uniform interface to other applications and servers (not shown), and grants access to retrieve data from the databases 100. Typically these other clients or servers would not be controlled by the same entity that provides the other components of the gaming network 5, and therefore the data interface 88 grants only guarded access to the databases 100. Other components of the gaming network 5 of FIGS. 1A and 1B are discussed in detail below.

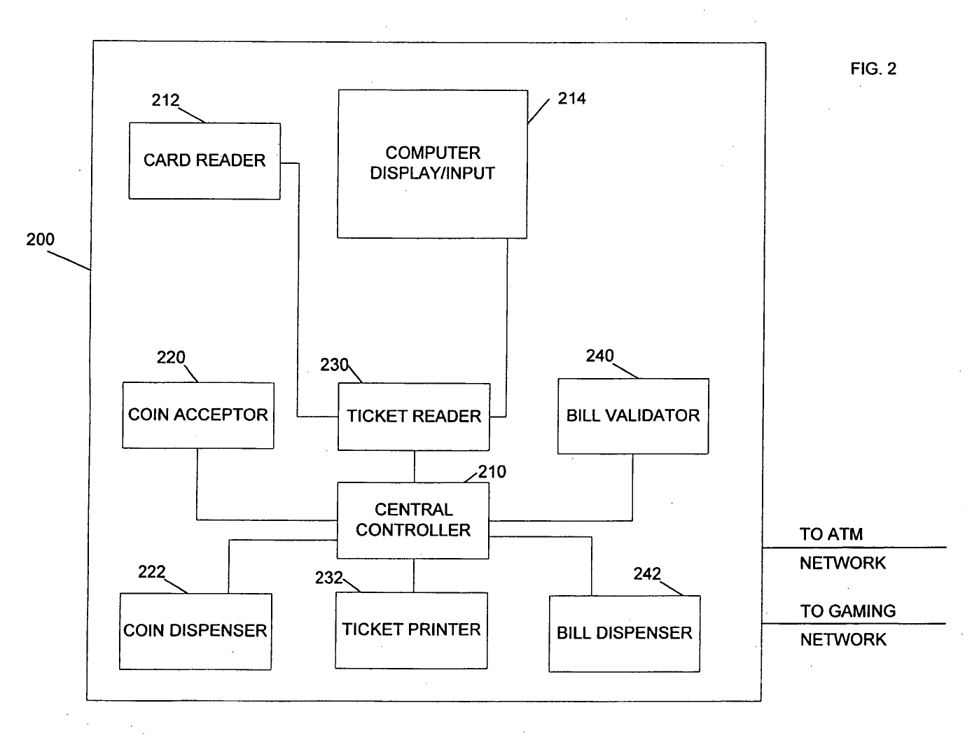

FIG. 2 is a functional block diagram of a stand alone service center 200 according to embodiments of the invention. A central computer or controller 210 may be used as the main conduit for communication and control of the service center 200. The controller 210 may be a main board that interfaces with various controller boards that control specific functions in the service center 200, or may control the various devices directly.

The controller 210 communicates to a card reader 212. When a patron uses the service center 200, the patron identifies himself or herself. One standard method for patron identification is to slide a player card or equivalent into the card reader 212. A pin code may also be required for complete identification. Of course, other identification methods are possible, such as biometric (fingerprint, eye, or other readers), RF based, or others, all of which are within the scope of this invention.

A display unit 214 is also coupled to the controller 210. The display unit produces screens to show to the patron, and to provide the patron control choices. The display 214 may be a touchscreen, or input can be retrieved from the patron from a keypad or set of buttons, a trackball, or other similar device. The service center 200 may also include a coin acceptor 220 and a coin dispenser 222, which can respectively accept and dispense coins and/or tokens. With the advent of electronic accounting and ticket based gaming using printed tickets for awards and accepting tickets as payment, reliance on coins and tokens will generally continue to lessen, and may eventually be eliminated. In such a case, it may still be beneficial to retain at least the coin acceptor 220, because the patron could still use the service center 200 to convert coin to other forms of monetary value, as described below.

Also connected to the central controller 210 in the service center 200 is a ticket reader 230 and a ticket printer 232. The ticket printer 232 may be of any known type in the art, such as impact, inkjet, thermal, laser, and can be a color printer or standard black and white. The ticket printer 232 may be used for printing a receipt at the end of a transaction at the service center 200, or for printing a ticket having value. Description of usage of the ticket printer 232 and the printed tickets for embodiments of the invention follows.

The ticket reader 230 may be a stand-alone piece of equipment or may be used in conjunction with a bill validator 240. In other words, the bill validator 240 may be able to also read tickets, and thus a separate ticket reader 230 is not required in such a service center 200. Either the ticket reader 230 or the so-equipped bill validator 240 can read tickets by reading a bar code printed on the ticket or by other identifying features on tickets or vouchers. Bill validator 240 authenticates bills by examining printing and other security features on paper currency. Bill validators are well known in the gaming arts. A bill dispenser 242 is also coupled to the central controller 210 and is used for dispensing currency bills to the patrons.

The self-service center 200 may be connected to the gaming network 5 which enables the patron to interact with and communicate with their player account. More specifically, FIGS. 1A and 1B illustrate the service center 200 as connected either to the bank controller 30, or to the server cluster 56. However, the service center 200 may be connected to any component in the gaming network 5 that can allow it to interface with the gaming network 5. The service center 200 may be coupled directly to the gaming network as a node on the network, or the coupling may be indirect, as through a gateway. The service center 200 may be coupled directly to one of the Ethernet hubs 46, to the concentrator 48, or to the data interface 88. There may be other components in the gaming network 5 to which the service center 200 can be coupled. The service center 200 may couple to the gaming network 5 over a secured wireless link, which could be beneficial in that additional wires would not have to be run to connect the service center to an existing game network.

Additionally, the service center 200 may be connected to an ATM network such that the patron could access a bank account or another type of account through the ATM network. Security on the gaming network 5 could be designed to meet the specifications and standards of security on the ATM network. Thus, transactions performed on both the gaming network 5 or the ATM network would be secure transactions.

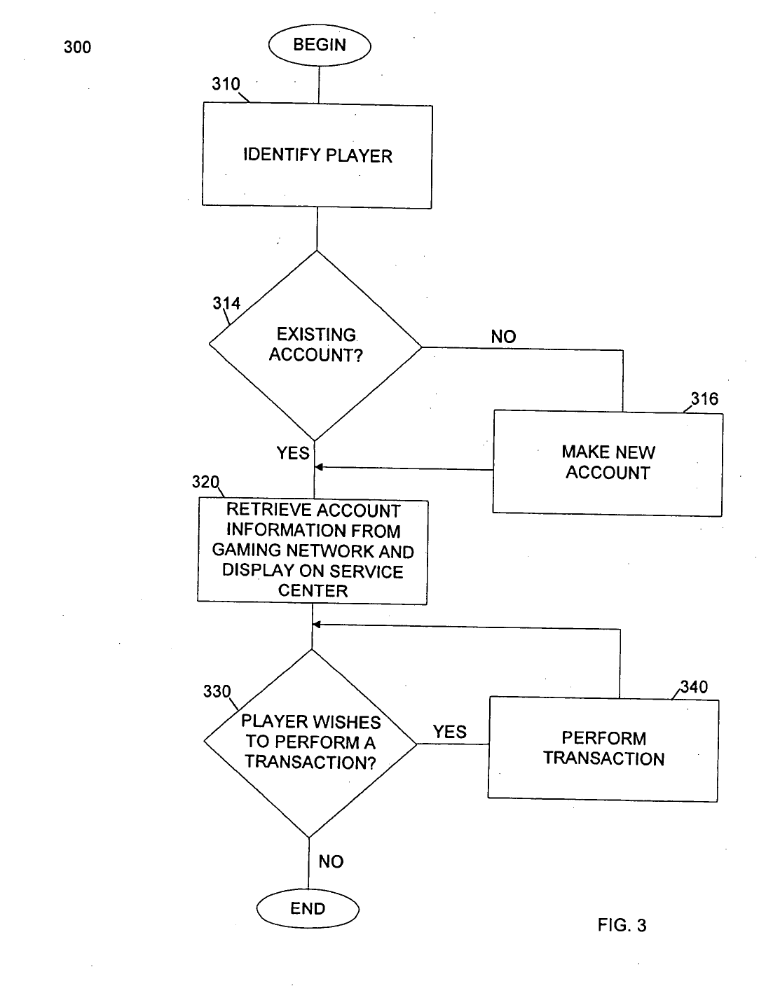

FIG. 3 is an example flow diagram of processes that can be performed on the service center 200 according to embodiments of the invention. The flow 300 begins at a step 310 where the player is identified. As described above, the player can be identified by inserting a card into the card reader 212, which may also require entering a correct PIN associated with the player's account. A process 314 determines if there is an existing player account already set up for the identified player. An account exists if data is stored under an identifier for the patron in the patron management database 94 (FIG. 1B), or elsewhere on the gaming network 5. If no existing account is found in the process 314, a new account is made in a process 316. In some establishments, only authorized personnel can make a new account in the process 316. One reason to require authorized personnel to make the account in the process 316 is so that authorized person can identify the player by a document that is presumed to be legitimate, such as a driver's license or a credit card. In this way, it is much less likely that a player will open a false account or multiple accounts for the same player.

Once account information appears for a player, or if there is already previously stored account information, the information is formatted and displayed on the display 214 of the service center 200 in the process 320. In addition to identifying the player, for instance by name, the initial screen shown on the display 214 can determine if the player would like to perform a transaction.

A decision block 330 determines if the player wishes to perform a transaction. Example transactions include: changing a correspondence address or other information in the account, or “cashing-in” some of their bonus loyalty points for another type of reward. Many types of transactions that can be performed in the process 340 are described below. If the player wants to perform a transaction, it is performed in the process 340 and the flow 300 loops back to the process 330 to determine if another transaction is desired.

After the player has completed all the desired transactions, the flow 300 exits the decision block 330 in the NO direction, and the flow 300 ends. After the flow 300 ends, the service center 200 may eject the player's identification card from the card reader, and reset itself to service another patron. For instance, the service center can show a welcome screen on the display 214, inviting anther patron to use it.

As introduced above, there are many transactions that can be performed on the service center 200. Generally, the service center can gather information from anywhere it is stored on the gaming network 5. For instance, data may be stored in any of the databases 100 (FIG. 1B), on one of the application clients 80, 82 that is coupled to the service cluster 56, or in one of the data repositories 61, 67, 69 (FIG. 1A), or in any acceptable place on the gaming network 5. After the proper information is gathered, it may store the information locally in the central controller 210 (FIG. 2), or in memory that is coupled to the controller (not shown).

Information and control screens are formatted with data pulled from the gaming. network 5, and shown to a patron of the service center 200 on the display 214. When the patron selects a transaction to perform, the service center 200 can perform the transaction, which may include generating data to be stored back on the gaming network 5. For instance, if a patron wishes to update their mailing address on the service center 200, the new address could be accepted from the patron and stored in the patron management database 92. The patron management database 92 may store the new and old addresses for the patron.

There are a near limitless number of transactions that a patron can perform at the service center 200. What follows is a description of a number of possible transactions, but the service center 200 is capable of performing other transactions, of course.

A patron can use the bill validator 240 or the ticket reader 230 to redeem a payout ticket. In some embodiments, after the player inserts his or her player tracking card in the card reader 212, or otherwise identifies himself or herself, the player can insert a ticket. In other embodiments, at least for some types of tickets, the player need not identify himself or herself. The service center 200 can scan barcodes or other coding on the ticket to identify the particular ticket. Once identified, data can be retrieved from the databases 100 to verify details of the ticket, such as its amount, date of issuance, expiration date, redemption status, etc. Once the player is authorized and the ticket has been verified that it has not been already paid, the service center 200 can pay the patron directly. For instance, the service center 200 can dispense bills from the bill dispenser 242 and/or coins from the coin dispenser 222. Also, the service center 200 may issue another ticket from the ticket printer 232. Reasons to exchange one ticket for another will appear below. Once a particular ticket has been validated and paid, a notation is made in the ticket wizard database 96 (or elsewhere in the databases 100) that the ticket has already been redeemed. This prevents the service center 200 from redeeming the same ticket multiple times if, for example, unscrupulous players would photocopy a ticket and attempt to redeem each of the photocopies.

A patron can also use the service center 200 as a money station. For instance, if the player has a large number of coins, he or she can feed the coins into the coin acceptor 220 and have the coin value dispersed as bills from the bill dispenser 242. Additionally a player could insert large denomination bills into the service center 200 and have smaller denomination bills distributed by the bill dispenser 242. The service center 200 may or may not require a player to identify himself or herself before performing these types of exchange transactions. However, for some type of exchange transactions, for instance to redeem a large number of large bills, the service center 200 may require that a player be identified as an extra security precaution.

Related to the exchange transactions described above, a player may convert a number of coins or bills into a ticket. For instance, if a player has a large number of coins and wants to move them from one machine to another, the player could exchange the coins for a ticket at the service center 200, and only carry the ticket to the new machine. Then the player would insert the ticket in the new machine and get credit for the exchanged coins. A notation of the ticket is made in the databases 100 and identified with the player so that the ticket can be later redeemed.

Identifying a particular player with a printed ticket has the advantage of allowing replacement tickets to be issued. For example, if a particular ticket is issued with a unique barcode, a notation of the particular barcode and player can be made in the databases 100. If the player loses the ticket but the ticket has not been redeemed, the service center 200 (or other authorized casino personnel) can issue a replacement ticket. To issue a replacement ticket, the service center 200 can bring up a list of all non-redeemed tickets by the particular identified player. Then the player can select a ticket to reissue from the non-redeemed list. The gaming network 5 is protected from redeeming multiple tickets because a notation of each ticket redemption is made in the database 100 along with the ticket identification. In other words, the ticket represents a particular transaction, and redemption of the ticket represents mere completion of the transaction, and not a “redemption” of the ticket itself.

Another advantage to coupling the service center 200 to the gaming network 5 is that funds may be uploaded to a player account. For instance, after identifying the player, bills, coins, tickets, electronic funds, funds from a smart card, debit card, or credit card, etc. can be accepted into the service center 200. After the player selects a transfer function from the computer input 214, funds can be transferred to the player's account. These funds can be later used by the player at an EGM 10 by being electronically transferred from the player account to a selected EGM 10. In other words, a player can first load funds into a player account at the service center 200, and then later transfer funds from a player account to an EGM 10 to purchase game plays. Or, the player could access their player account at the service center 200 and purchase tickets or obtain bills.

Additionally, if the player has a casino credit account, the service center 200 could be used to take value from the casino credit account by getting cash, one or more tickets, or by transferring it to a player account, for instance. Further, the player could repay casino credit that has been extended, by, for instance, entering cash or tickets into to the service center 200 with instructions to make a payment to the player's casino credit account.

If the service center 200 is connected to an ATM network, the service center 200 could transfer funds from an account accessible over the ATM network, such as a bank account, into the player account on the gaming network 5. Different identifications cards may have to be used, one for each network. At a minimum, if the service center 200 is connected to both the ATM network and the gaming network 5, a player could retrieve cash from their bank account over the ATM network, identify themselves to the gaming network 5, and then insert the cash into the bill validator 240 to be applied to their player account. With communication between the ATM network and the gaming network 5, the service center 200 could directly transfer money from a bank, credit card, smart card, or debit account directly into the player account.

Simply stated, the service center 200 could be used as an intermediary to help perform transactions between entering value into the service center by any possible way, and by retrieving value from the service center, by any possible way. For instance, a player could enter bills into the service center 200 and get tickets out. Or, the player could enter value from a smart card into the service center 200 and make a payment to a casino credit account.

Multiple transactions or split transactions could also be performed, where, for instance, a player enters $150 value to the service center 200 from a credit card, transfers $75 to a player account, and gets a ticket for $75.

During or at the conclusion of any transaction, the ticket printer 232 can also be used to print a receipt for any transaction performed on the service center 200.

Another function of the service center 200 is to provide account status requests about a player's account. For instance, once a player is identified, the player can select to receive account information, for example by selecting an account status option from the display/input 214 of the service center 200. Once selected, various information about the player's account can be provided to the player by displaying it on the display 214 or printing it on the ticket printer 232. For instance, the number of bonus loyalty points, amount of cash value associated with the player account, historical data of any player, name, address, birth date and any other information that is stored in the player account for that particular player may be able to be displayed. Of course some information that is stored in the player account may be kept secret from the player, at the casino's discretion.

In another transaction on the service center 200 a player can redeem loyalty points on a player account directly for cash. In such a transaction, after identifying themselves at the service center 200, a player selects some or all of the bonus loyalty points for cash out. After the player confirms the cash out request, the service center 200 can dispense bills from the bill dispenser 242 or a ticket from the ticket printer 232 for the amount requested. The amount of cashed-out loyalty points are deducted from the player's account and the new value stored back in the databases 100.

In another action, the service center 200 allows patrons to redeem coupons for prizes, comps (complementary items), sweepstake entries, and system bonuses. The coupons may be delivered to a player by an EGM 10, or by some other means, such as being sent in the mail, given to patrons when they check into a casino hotel, or clipped from a newspaper. For instance, a player playing a game on an EGM 10 may hit a certain combination or play for a length of time that triggers a prize, comp, sweepstakes entry, and/or system bonus to be delivered to the player. Regarding coupons sent by mail or clipped from newspapers or magazines, an entry in the databases 100 can be made within each player account when such a coupon is redeemed. In this manner, the patron could only redeem one coupon per player account.

The computer display 214 on the service center 200 can provide graphical animation for sweepstakes and promotional purposes to carded and non-carded players alike. For instance, the service center 200 can make sounds or play music to grab the attention of a casino patron. Messaging or an animation can invite the casino patron to become a carded player or can offer an already carded player some benefit. After the already carded player identifies him or herself to the service center 200, the ticket printer 232 could print out a coupon specific for that player. Messages on the service center 200 could change at different times for different promotions.

An additional function of the service center 200 can be to support casino personnel. For instance, if a player wins a jackpot at an EGM 10, a casino employee could verify the jackpot, and request a jackpot ticket printed for the casino employee. The casino employee could then take the jackpot ticket to the service center 200, identify him or herself to the service center as a casino employee, and obtain payment for the jackpot. The casino employee would then take the jackpot payout and give it to the winning patron. Similarly, after the jackpot was verified by the casino personnel, the employee could have a jackpot ticket printed, which the player could then take to the service center 200 for payment.

Other types of support for casino personnel could also be supplied by the service center 200. For instance, if a casino employee had a bank for paying jackpot or other payouts, the casino employee could “refill” his or her bank as funds became depleted. Of course, proper accounting procedures and verification mechanisms would ensure the proper payments are made to the proper parties.

In another action, the service center 200 could be used to print W-2 forms for large jackpot wins. Similarly, the service center 200 could print a ticket or voucher that could be presented at a casino cage where a W-2 form could be printed.

As can be seen, there are various ways that the service center 200 can interact with patrons and casino personnel to make casino accounts more accessible and to enhance the relationship between a casino and their patrons.

Although examples of machines and processes have been described herein, nothing prevents embodiments of this invention from working with other types of machines and processes. Implementation of the service center is straightforward in light of the above description. As always, implementation details are left to the system designer. The specific screens, circuits, and procedures used to manage player accounts may be implemented in any way, with any components, so long as they can generate the desired effect. Inclusion of description or illustration of a function in either the gaming device or the gaming network is not dispositive that the function is located in or must be performed there. Additionally, the service center system can work even when not all of the illustrated functions are present.

Thus, although particular embodiments for a player account management system have been discussed, it is not intended that such specific references be considered as limitations upon the scope of this invention, but rather the scope is determined by the following claims and their equivalents.

What is claimed is:

1. A service center coupled to a gaming network and to an automatic teller network, comprising:
a player identifier structured to validate a user as a holder of a player account on the gaming network;
a ticket reader;
a verifier coupled to the player identifier and the ticket reader, and structured to validate a ticket that is inserted into the ticket reader; and
a payment dispenser structured to eject from the service center an amount of value after the ticket is validated.

2. The service center of claim 1 wherein the ticket reader is a bill validator.

3. The service center of claim 1, further comprising a ticket printer.

4. The service center of claim 3 wherein the ticket printer is configured to print a tax form.

5. The service center of claim 1 wherein the player identifier is also structured to validate the user as an employee.

6. A service center structured to be coupled to a gaming network and to an automated teller network, the service center comprising:
a ticket printer structured to print a ticket after receiving a command from the gaming network.

7. The service center of claim 6 wherein the command is generated from a gaming device coupled to the gaming network.

8. The service center of claim 6 wherein the ticket printer is structured to deliver a bonus generated on the computer network.

9. The service center of claim 6 wherein the service center is a node on the gaming network.

10. A standalone service center that is coupled to a gaming network and that is structured to:
present transaction choices to a user and accept a selected choice;
verify an identity of a user having a player account;
accept a ticket at a ticket reader;
validate the accepted ticket by comparing it to data stored on the gaming network; and
provide a benefit to the user.

11. The service center of claim 10 in which the service center is structured to provide a benefit to the user by providing currency to the user.

12. The service center of claim 10 in which the service center is structured to provide a benefit to the user by providing a new ticket to the user.

13. The service center of claim 10 in which the service center is structured to provide a benefit to the user by adding a benefit to the player account.

14. The service center of claim 10 wherein the service center is further structured to establish a data connection with an ATM network.

15. The service center of claim 14 wherein the service center is structured to transfer account value from an account on the ATM network to the player account.

16. A method of servicing a player account, comprising:
accepting an input at a station that is coupled to a gaming network;
identifying a player having an account based on the input;
accepting a ticket at a ticket reader;
verifying authenticity of the ticket;
providing something of value to the player; and
recording that the ticket has been redeemed.

17. The method of claim 16 wherein providing something of value comprises adding value to a player account.

18. The method of claim 16 wherein providing something of value comprises ejecting currency from the station.

19. The method of claim 16 wherein providing something of value comprises printing another ticket from the station.

20. The method of claim 16 wherein the station does not include a gaming device.

21. A method of servicing a player account at a service center coupled to a gaming network on which a plurality of player accounts are stored, the method comprising:
establishing a data connection to the gaming network;
accepting an identification of a user;
comparing information from the identification to user data stored on the gaming network;
authorizing the user when the information matches the stored user data;
accepting a ticket from the user;
comparing data from the ticket to ticket data stored on the gaming network; and
providing something of value to the user if the data from the ticket matches the stored ticket data.

22. The method of claim 21, further comprising:
establishing a data connection to an ATM network; and
transferring money from an account on the ATM network to the player account of the authorized user.

23. The method of claim 21, further comprising:
comparing information from the identification to employee data stored on the gaming network; and
authorizing an employee if the information from the identification matches the stored employee data.

24. The method of claim 23, further comprising:
providing currency to the authorized employee; and
storing a record of providing the currency on the gaming network.
